(19) United States
(12) Patent Application Publication
(10) Pub. No.: US 2016/0273584 A1
(43) Pub. Date: Sep. 22, 2016

(54) ROLLING BEARING

(71) Applicant: SCHAEFFLER TECHNOLOGIES AG & CO. KG, Herzogenaurach (DE)

(72) Inventors: Wolfgang BRAUN, Garstadt (DE); Vasilios BAKOLAS, Herzogenaurach (DE)

(73) Assignee: Schaeffler Technologies AG & Co. KG, Herzogenaurach (DE)

(21) Appl. No.: 15/031,472

(22) PCT Filed: Sep. 30, 2014
(86) PCT No.: PCT/DE2014/200522

§ 371 Date: Apr. 22, 2016

(30) Foreign Application Priority Data
Oct. 25, 2013 (DE) 10 2013 221 685.8

(51) Int. Cl. F16C 33/32; F16C 33/58

(52) U.S. Cl. CPC F16C 33/32; F16C 33/583; F16C 2202/28; F16C 2204/52; F16C 2240/76

(57) ABSTRACT

A rolling bearing includes balls made of a shape memory alloy, in particular Nitinol 60, as rolling elements which roll on at least one bearing ring comprising a groove-shaped raceway. The balls contact the raceway with at least 108% osculation.

### FIELD OF THE INVENTION

The invention relates to a rolling bearing according to the preamble having rolling bodies, namely balls, made from a shape memory alloy, in particular, a nickel-titanium alloy.

### BACKGROUND

From U.S. Pat. No. 6,886,986 B1, rolling bearings made from a nickel-titanium alloy, namely Nitinol 60, are known. For producing the rolling bodies, a ceramic casting mold is used. After the casting, additional processing steps are provided that include a polishing of the Nitinol balls

Nickel-titanium alloys are distinguished by a high corrosion resistance for a simultaneously high hardness, wherein they are basically suitable for rolling bodies in bearings that are operated under unfavorable ambient conditions, especially insufficient lubrication and/or exposure to aggressive media.

### SUMMARY

The invention is based on the objective of expanding the possible uses of rolling bearings, namely ball bearings, with rolling bodies made from a shape memory alloy relative to the cited prior art.

This object is achieved by a rolling bearing constructed as a ball bearing with one or more features of the invention. The rolling bearing has rolling bodies that have a known basic structure made from a shape memory alloy and roll between two raceways of bearing rings or between a raceway of one bearing ring and a raceway located directly on a shaft, wherein at least one raceway has a groove-like shape. A raceway of the rolling bearing can also be formed directly by a housing part. According to the invention, the balls contact the groove-shaped raceway with an osculation of at least 108%. In this case, osculation is understood to be the ratio between the radius of the groove forming the raceway and the radius of the ball.

A nickel-titanium alloy is suitable as the material for producing the bearing part of the rolling bearing that is called bearing ring without restricting its generality and has the groove-shaped raceway. Advantageously, the alloy has a nickel content indicated in weight percent of greater than 55%. In particular, the alloy is Nitinol 60 (60% nickel, 40% titanium) for producing the bearing ring.

In comparison to the prior art, the osculation has a relatively high value. This means that the raceway on which the ball rolls has a relatively flat construction, so that the contact surface between the ball and the bearing ring tends to be reduced. This has the basic effect of reducing the load-bearing capacity of the rolling bearing. In the present case, thanks to the use of rolling bodies made from a shape memory alloy, in particular, a nickel-titanium alloy, however, this effect is minimal, because such alloys have a significantly lower modulus of elasticity than steel. The high elastic flexibility of shape memory alloys, in particular, nickel-titanium alloys, in comparison with steel, overcompensates for the load-bearing-capacity-reducing effect of a comparatively large radius of the groove in which the balls roll in relation to the dimensioning of the balls.

In one advantageous construction, the balls of the rolling bearing are made from a material whose modulus of elasticity is less than 60% of the modulus of elasticity of the bearing ring on which the balls roll. Preferably, the modulus of elasticity of the balls is at most 120 GPa. In contrast, the bearing rings preferably have a modulus of elasticity of greater than 200 GPa.

Due to the reduction of the contact surface area between the bearing ring and rolling bodies associated with the increase in the value of the osculation, in comparison with conventional bearings with narrower osculation, especially for operation with low loads, the friction and thus also the development of heat in the bearing is reduced. The rolling bearing having an especially wide osculation with a value of at least 108% is therefore suitable especially for operation under unfavorable lubrication conditions and thus in many cases also unfavorable conditions of heat dissipation.

The mentioned minimum value of the osculation in the magnitude of 108% applies in preferred construction for the inner ring of a rolling bearing constructed as a grooved ball bearing, while the outer ring of such a ball bearing has an osculation of at least 110%. For embodiments of the rolling bearing that have an osculation of greater than 108% on the inner ring, an even larger osculation is preferably also given on the inner ring. The value of the osculation on the outer ring is, for example, greater than 1.05 times the value of the osculation on the inner ring.

An osculation of 108% on the inner ring produces a pressure that corresponds approximately to the pressure for a conventional inner ring made of steel with 103% osculation. On the outer ring, the pressure for a rolling bearing constructed according to the invention with 117% osculation corresponds to the pressure for a conventional bearing with approximately 105% osculation on the outer ring.

Another advantage of the production of the balls of the rolling bearing from a nickel-titanium alloy, advantageously Nitinol 60, lies in the significantly lower density of such an alloy in comparison with steel. The rolling bearing is thus especially suitable for high rotational speeds, even under very unfavorable lubrication conditions.

The surface hardness of the rolling bodies is greater than 58 HRC in the preferred construction, wherein hardness values up to 62 HRC can be reached. The rolling bodies of the rolling bearing can be subjected to a heat treatment. Other advantages of the rolling bodies produced from a shape memory alloy include their compatibility with lubricants, their corrosion resistance, and their wear resistance.

The bearing rings of the rolling bearing are made from steel, for example, from common rolling bearing steel or from a corrosion-resistant steel. Steel that is available under the designation Cronidur (X 30 CrMoN 15 1; material number 1.4108) has proven to be especially suitable.

A preferred field of application of the rolling bearing is rapidly rotating and media-lubricated bearings. Media lubrication is generally understood to be a loading of the rolling contact surfaces with a medium that is not primarily provided for lubrication. This could be, for example, a fluid that is fed with the pump or compressor supplied with the rolling bearing. The use of a rolling bearing in a non-sealed or only partially sealed design under water, especially in seawater, is also considered a media-lubricated operation of a rolling bearing.

### BRIEF DESCRIPTION OF THE DRAWINGS

An embodiment of the invention is described in more detail below with reference to the drawings. Shown herein are:

FIG. 1 a rolling bearing with rolling bodies made from a shape memory alloy in a sectional representation,

FIG. 2 in a diagram, the relationship between osculation and pressure in rolling bearings according to the invention on one hand, and a comparison rolling bearing, on the other hand.

### DETAILED DESCRIPTION OF THE PREFERRED EMBODIMENTS

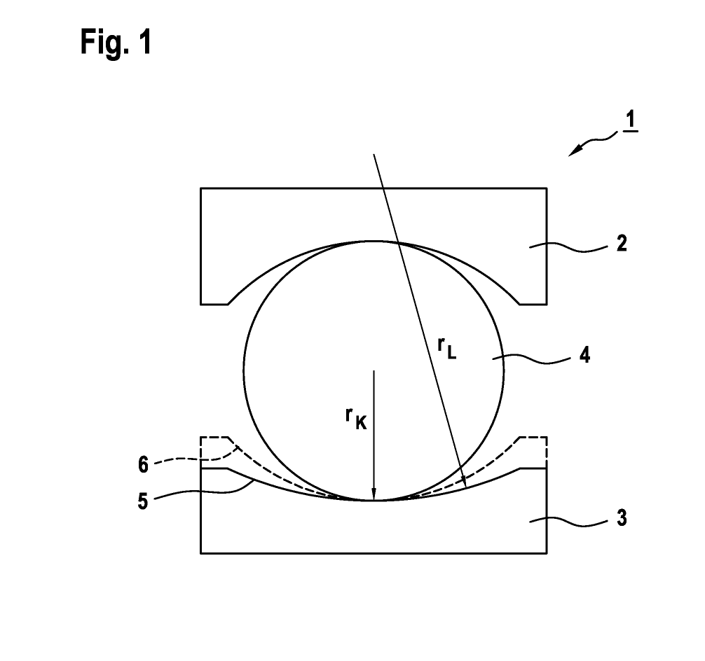

FIG. 1 shows a rolling bearing that is designated overall with the reference symbol 1 and has two bearing rings 2, 3, namely an outer ring 2 and an inner ring 3, between which roll rolling bodies 4. The rolling bodies 4 are constructed as balls made from Nitinol 60 (60% Ni, 40% Ti). The groove-shaped raceways of the bearing rings 2, 3 on which the balls 4 roll are marked with the reference symbols 5. In addition to the shown raceway 5 of the rolling bearing 1, the example of the inner ring 3 also shows a comparison raceway 6 that has tighter osculation on the ball 4 and corresponds to the contour of a bearing ring of a non-loaded, conventional rolling bearing, namely radial grooved ball bearing.

The radius of the ball 4 is marked in FIG. 1 with r_{K}; the radius of the raceway 5 with r_{L}. The ratio between the raceway radius r_{L} and the ball radius r_{K} is significantly greater than 108% and is defined as osculation. In comparison to conventional bearing constructions that are indicated by the contour of the comparison raceway 6, the osculation of the rolling bearing 1 is exceptionally wide. In the mechanically unloaded or minimally loaded state, as shown in FIG. 1, a significantly smaller contact surface between the rolling body 4 and the raceway 5 is produced in comparison to bearings with narrower osculation.

This is, however, overcompensated, at least for the operation of the rolling bearing 1 under high mechanical loading, in that the modulus of elasticity of the rolling body 4 with 114 GPa is only somewhat greater than half as large as the elasticity of modulus of the bearing rings 2, 3. The bearing rings 2, 3 are made from steel with a modulus of elasticity of 208 GPa. The density of the material with the shape memory properties, from which the rolling body 4 is made, is between 6 and 7 g/cm³ and is thus considerably lower than the density of steel. Accordingly, centrifugal forces occurring during the operation of the rolling bearing 1 are significantly reduced in comparison with conventional rolling bearings with rolling bodies made from steel.

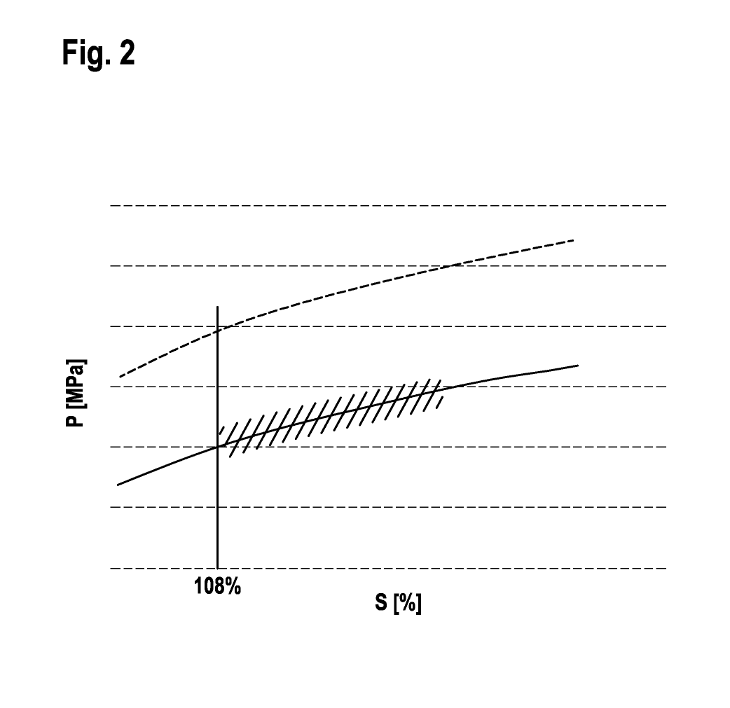

The relationships between osculation S (in %) of the rolling bearing 1, maximum pressure P (in MPa) in contact between rolling bodies 4 and raceway 5, as well as modulus of elasticity of the rolling bodies 4, are shown in FIG. 2. Properties of a conventional grooved ball bearing, which has balls made from common rolling bearing steel, for example, 100Cr6, are shown by a dashed line in FIG. 2. At higher values of osculation, that is, for flatter raceways, the maximum pressure in the rolling contact increases significantly. This relationship is basically visible also in the rolling bearing 1 according to the invention according to FIG. 1, as described in FIG. 2 by a rising, solid line. Due to the significantly lower modulus of elasticity of the rolling bodies 4 in the rolling bearing 1 according to the invention in comparison with the conventional rolling bearing, the pressure P that acts in rolling contact is drastically reduced. The preferred area of the osculation of the rolling bearing 1 is emphasized in FIG. 2 by shading placed over the solid line.

The entire solid line that shows properties of embodiments of the rolling bearing 1 according to the invention (from 108% osculation) is significantly below the dashed line that shows properties of a conventional comparison rolling bearing. Even the highest point within the shaded area, which stands for a bearing with very wide groove in comparison with the ball radius, is below the maximum pressure that occurs in a conventional bearing with steel balls and extremely narrow osculation (lowest point of the dashed line).

Another advantage of the very wide osculation of the rolling bearing 1 according to the invention is that, in comparison with conventional grooved ball bearings, a larger axial offset between the bearing rings 2, 3 is possible, as well as a larger error in angle between the parts that can rotate relative to each other and are supported by means of the rolling bearing 1 is acceptable.

Due to the material of the rolling bodies 4 and the described geometric relationships, the rolling bearing 1 is distinguished by an especially high corrosion resistance and wear resistance, wherein very different lubricants can be used and even non-lubricated operation is possible within limited rotational speed and load ranges.

### LIST OF REFERENCE NUMBERS

1 Rolling bearing
2 Outer ring
3 Inner ring
4 Rolling body, ball
5 Raceway
6 Comparison raceway
P Pressure
r_{L} Radius of the raceway
r_{K} Ball radius
S Osculation

1. A rolling bearing comprising: balls made from a shape memory alloy as rolling bodies, at least one bearing ring having a groove-shaped raceway in which the balls roll, and the balls contact the raceway with an osculation of at least 108%.

2. The rolling bearing according to claim 1, wherein the balls are produced from a nickel-titanium alloy with a nickel content of greater than 55 wt. %.

3. The rolling bearing according to claim 2, wherein the balls contain 60 wt. % nickel and 40 wt. % titanium.

4. The rolling bearing according to claim 1, wherein the balls have a surface hardness of greater than 58 HRC.

5. The rolling bearing according to claim 1, wherein the balls have a modulus of elasticity of at most 120 GPa.

6. The rolling bearing according to claim 1, wherein a modulus of elasticity of the balls is less than 60% of a modulus of elasticity of the at least one bearing ring.

7. The rolling bearing according to claim 1, wherein there are two of the bearing rings, and the bearing rings are made from a stainless steel.

8. The rolling bearing according to claim 1, wherein the balls contact one of the bearing rings that is constructed as an outer ring with a different osculation than a second one of the bearing rings that is constructed as an inner ring.

9. The rolling bearing according to claim 8, wherein osculation on the outer ring is at least 110%.

10. A method for using the rolling bearing according to claim 1, comprising using water as a lubricant for the bearing.

11. The rolling bearing of claim 7, wherein the stainless steel is a 1.4108 stainless steel.
